(19) United States
(12) Patent Application Publication
(10) Pub. No.: US 2012/0143620 A1
(43) Pub. Date: Jun. 7, 2012

(54) METHOD AND SYSTEM FOR DETERMINING A PATIENT'S RESPONSIBILITY TO A PROVIDER

(75) Inventors: David Linetsky, Brooklyn, NY (US); Dan Nathan, Maynard, MA (US); Edouard Valla, New York, NY (US)

(73) Assignee: PHREESIA, New York, NY (US)

(21) Appl. No.: 13/309,912

(22) Filed: Dec. 2, 2011

Related U.S. Application Data
(60) Provisional application No. 61/419,748, filed on Dec. 3, 2010.

(51) Int. Cl. G06Q 50/22; G06Q 20/14; G06Q 40/08

(52) U.S. Cl. 705/2

(57) ABSTRACT

A method and system for determining a patient's responsibility to a provider includes a point of service device and a patient responsibility calculator. The point of service device receives information from the patient upon the patient checking in at the provider's location. Upon check in, the patient responsibility calculator determines substantially in real-time the amount owed by the patient for a service to be rendered prior to the patient receiving the service. The patient responsibility calculator utilizes information regarding the patient's insurance plan from the patient's insurance provider to determine the amount owed by the patient for the services. Once the amount owed by the patient is calculated, the point of service device prompts the patient for payment and processes payment.

### CROSS-REFERENCE TO RELATED APPLICATIONS

This application claims priority to U.S. provisional application Ser. No. 61/419,748 entitled, “Method and System for Determining a Patient's Responsibility to a Provider”, filed on Dec. 3, 2010, the entire contents of which are hereby incorporated by reference.

### STATEMENT REGARDING FEDERALLY SPONSORED RESEARCH OR DEVELOPMENT

Not applicable.

### REFERENCE TO A SEQUENCE LISTING, A TABLE, OR COMPUTER PROGRAM LISTING COMPACT DISC APPENDIX

Not applicable.

### BACKGROUND OF THE INVENTION

The invention relates generally to a method and system for determining a patient's responsibility to a provider, and more specifically to a method and system for determining a patient's overall responsibility to a health provider in substantially real-time upon the patient checking in at the provider's office and for collecting the patient's responsibility at a point of service device upon check in.

Traditionally, when a patient arrives at a medical provider's office, the patient checks in with a human office administrator. The office administrator collects the patient's name and any applicable insurance information. The office administrator may or may not enter this information into a patient's physical file or a patient's electronic file.

After check in, the patient receives the services for which the patient is visiting the medical professional. The services provided during the visit are then processed by the provider's billing staff. The billing staff may contact the patient's insurance company to receive payment for the portion owed by the insurance company under the patient's benefits. The billing staff may also issue an invoice to the patient.

In some cases, the office administrator or the provider's billing staff may collect the portion due from the patient prior to the patient receiving services. In these cases, however, the office administrator or billing staff determines the amount due by simply asking the patient for their standard co-pay amount or may consult the patient's insurance card to determine the patient's co-pay amount. The amount collected may not be correct. The office administrator or billing staff do not contact the insurance company substantially in real-time to determine the patient's eligibility for insurance or the amount of the patient's responsibility for a particular service prior to the patient receiving the service. The office administrator or billing staff must also then enter any payments received into the provider's billing system.

These steps of checking in with a human office administrator and having billing staff process payments are cumbersome, inefficient and prone to human error. The conventional process also includes significant delays in the provider receiving full payment for services rendered. What is desired then is a system which eliminates the delay in claims processing and the associated administrative costs. What is also desired is a system that accurately determines the amount of the patient's responsibility to a provider and is able to collect this amount immediately upon the patient's check in and prior to the patient receiving services.

### SUMMARY OF THE INVENTION

The invention relates generally to method and system for determining a patient's responsibility to a provider. The system includes a point of service device and a patient responsibility calculator. The point of service device receives information from a patient and is able to processes payment transactions. The patient responsibility calculator determines substantially in real-time the amount owed by the patient for a service to be rendered prior to the patient receiving the service.

In one embodiment, the patient responsibility calculator further includes an insurance data processing system. The insurance data processing system contacts the patient's insurance provider and receives information relating to the patient's insurance plan from the insurance provider. The insurance data processing system is capable of interpreting data from different insurance companies. In one such embodiment, the patient responsibility calculator utilizes the information from the insurance data processing system to determine the amount owed by the patient. The insurance data processing system may determine if the patient has insurance, whether the patient's insurance is valid and the coverage provided by the patient's insurance. In one embodiment, rather than contacting the patient's insurance provider, the insurance data processing system contacts a clearing house that stores information for a plurality of insurance companies and receives the information relating to the patient's insurance plan from the clearinghouse. In another embodiment, the insurance data processing system must exceed a predetermined certainty threshold in order to provide insurance coverage information to the patient responsibility calculator.

In other embodiments, the system may also include a payment database that stores amounts previously charged to a patient for various services. In this embodiment, the patient responsibility calculator uses the amount previously charged to the patient to determine the amount owed by the patient for the service. In other embodiments, the patient responsibility calculator utilizes a predetermined amount to be charged to a patient for a service to determine the amount owed by the patient. The patient responsibility calculator may also utilize any outstanding patient balances to determine the amount owed by the patient.

In various embodiments, the patient responsibility calculator may receive data from several different databases. For example, the patient responsibility calculator may receive data from the provider's practice management system, the provider's practice finance department and a third party billing company.

One object of the invention is to have a system that calculates a patient's overall responsibility to a provider. A second object of the invention is to have a system that calculates a patient's responsibility to a provider prior to the patient receiving the service for which the patient is visiting the provider. A further object of the invention is to accurately determine the amount owed by the patient under the patient's insurance benefits. An overall object of the invention is to enable a patient to check in at a provider's office and tender payment for services without having to interact with human staff.

### BRIEF DESCRIPTION OF THE DRAWINGS

The invention is pointed out with particularity in the appended claims. The above and further advantages of this invention may be better understood by referring to the following description taken in conjunction with the accompanying drawings, in which:

FIG. 1 is a block diagram of an embodiment of a system for determining a patient's responsibility to a provider;

FIG. 2 is flowchart representation of an embodiment of a process for determining a patient's responsibility to a provider; and

FIG. 3 block diagram of another embodiment of a system for determining a patient's responsibility to a provider.

Like reference characters in the respective drawn figures indicate corresponding parts.

### DETAILED DESCRIPTION OF THE INVENTION

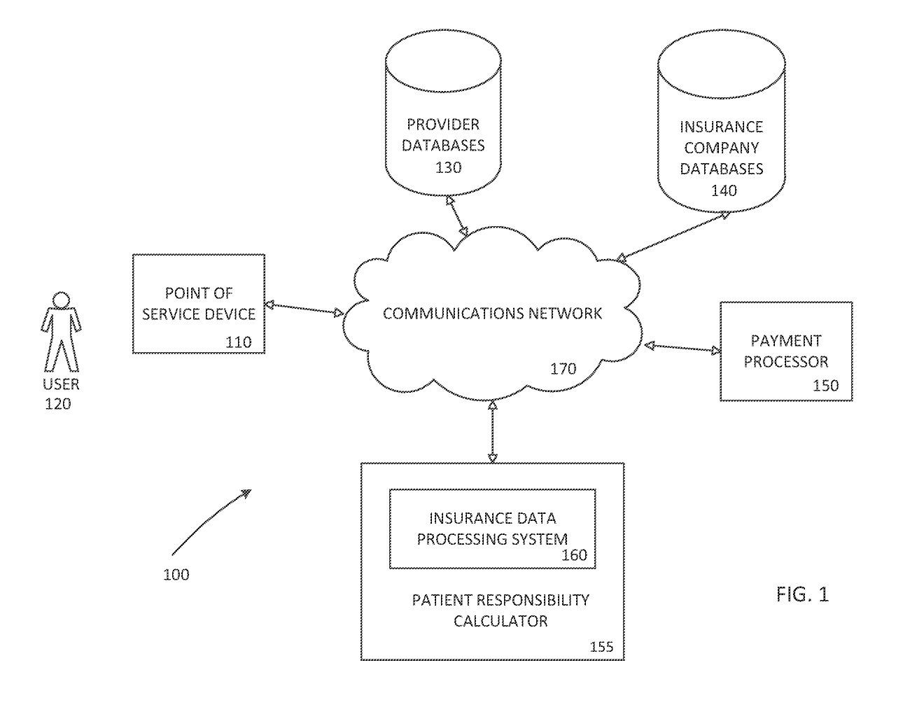

Referring to FIG. 1 and in brief overview, an embodiment of a system 100 constructed in accordance with the invention includes a point of service device 110 for interacting with a user 120, one or more provider databases 130, one or more insurance company databases 140, a payment processor 150, and a patient responsibility calculator 155. In the embodiment shown, the point of service device 110, one or more provider databases 130, one or more insurance company databases 140, the payment processor 150, and patient responsibility calculator 155 are connected via a communications system 170. The communications system 170 may be any type of communication system by which the system 100 components may communicate. For example, the communications system 170 may be a global communications network such as the Internet or World Wide Web. In other embodiments, the communications system 170 may comprise several different types of communications networks. For example, the point of service device 110 may communicate with the provider databases 130 over an intranet, yet communicate with the insurance company databases 140 over the Internet.

The user 120 may be a patient or someone acting on behalf of the patient. The user 120 interacts with the system 100 through the point of service device 110. The point of service device 110 may be a computer terminal, tablet, or any other type of device that may present information and collect information from the user 120. The point of service device 110 may include a traditional keyboard or may include a touch screen for receiving inputs from a user 120. An example of a point of service device is the patient check-in device available from Phreesia. Upon arriving at the provider's office, the user 120 “checks in” using the point of service device 110. Upon checking in, the user 120 provides the user's name and other information that may be relevant to the user's 120 visit. The user 120 may provide basic contact information such as residence, phone number and email address. The user 120 may also provide insurance information and update their health record to include changes in their medications and any other health changes. Finally, in one embodiment, the user 120 enters the purpose of their visit. In another embodiment, the purpose of the user's 120 visit is already in the system 100 and the user 120 simply confirms the purpose.

The provider databases 130 are the databases maintained by the health care provider or utilized by the provider and may include practice management systems, third party billing companies and provider's practice finance departments.

The insurance company databases 140 are the databases maintained by the different insurance companies. The insurance company databases 140 are used to determine if a patient is eligible for insurance benefits. The insurance company databases 140 are used to determine if a patient has insurance, if the patient's insurance policy is valid, and what payments a patient must make to cover copayments, deductibles or uninsured procedures. In another embodiment, the insurance company databases 140 are replaced with a clearinghouse that stores information for a plurality of insurance providers.

The payment processor 150 may be any system that may process payments. For example, the payment processor 150 may be a credit card company or a bank that processes debit payments.

The patient responsibility calculator 155 determines the amount of payment due from the patient for a service to be rendered, prior to the patient receiving the service. In one embodiment, the patient responsibility calculator 155 determines the amount owned by the patient substantially in real-time. In another embodiment, the patient responsibility calculator 155 includes an insurance data processing system 160 which receives the information about a patient's insurance plan and is able to “mine” the patient co-pay, co-insurance, deductible and other payment information from the information received from the patient's insurance company or the clearinghouse. The different insurance providers use many different formats for encoding information about insurance plans. As there are a large number insurance providers and a large number of insurance plans, the insurance providers have encoded the data in numerous different formats. The insurance data processing system 160 has previously been “trained” to read the information from the different insurance providers (or clearinghouses) and has learned to correctly determine a patient's responsibility under different insurance plans. In one embodiment, the insurance data processing system 160 learned to correctly determine the amounts over time, by analyzing training data produced by human operators. Machine learning systems are well known in the art, however, they have not been applied to analyzing data stored by medical insurance companies. In one embodiment, the insurance data processing system 160 is kept up-to-date by integrating feedback from users regarding the accuracy of its calculations. In another embodiment, the insurance data processing system 160 returns the most likely amount of the patient's 120 responsibility. In another embodiment, the insurance data processing system 160 must satisfy a certainty threshold in order to return an amount of the patient's 120 responsibility. For example, in one embodiment, the amount calculated by the insurance data processing system 160 must have at least a 95% chance of being the actual amount of the patient's responsibility (as determined by the insurance data processing system using statistical techniques) or the insurance data processing system 160 will return that it is unable to calculate the amount. In other embodiments, lesser or greater certainty is required.

In other embodiments, the patient responsibility calculator 155 may be part of the point of service device 110. In yet other embodiments, the insurance data processing system 160 is a separate system from the patient responsibility calculator 155 and the patient responsibility calculator 155 contacts the insurance data processing system 160 to retrieve information relating to the patient's insurance.

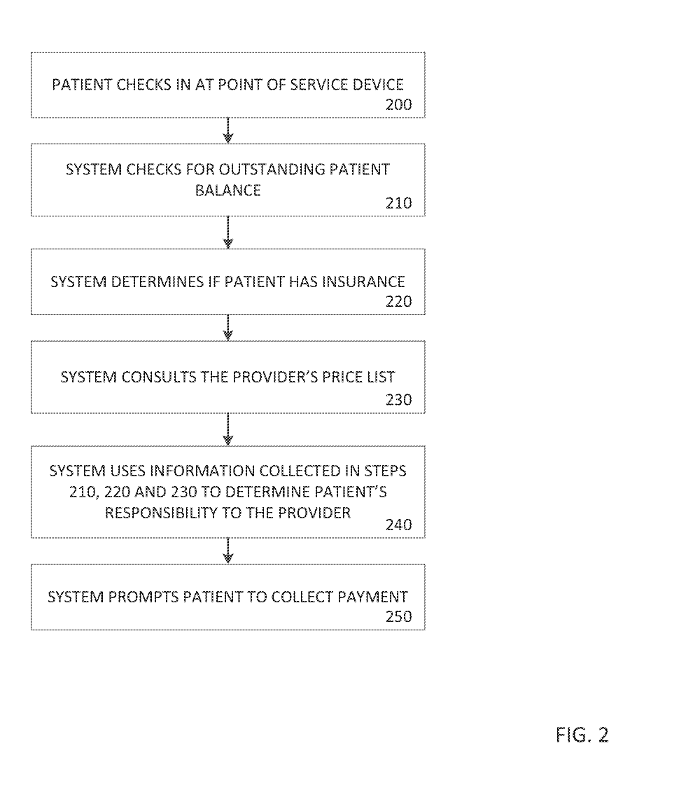

The operation of the system 100 is described with reference to the flowchart of FIG. 2. In step 200, the patient 120 checks in upon arrival at the medical provider's office using the point of service device 110. The point of service device 110 may simply be available in the medical provider's office or the patient 120 may receive the point of service device from an assistant at the office. As described above, upon checking in by using the point of service device 110, the patient 120 may provide or confirm basic contact information such as residence, phone number and email address. The patient 120 may also provide or confirm current insurance information and update their health record to include changes in their medications and any other health changes. Finally, in one embodiment, the patient 120 enters the purpose of their visit. In another embodiment, the purpose of the patient's 120 visit is already in the system 100 and the patient 120 simply confirms the purpose.

Next, in step 210, the point of service device 110 contacts the patient responsibility calculator 155 to determine the amount owed by the patient. The patient responsibility calculator 155 contacts the provider databases 130 to determine if the patient has any outstanding balances. The outstanding balance amounts can be determined using multiple sources, such as practice management systems, the medical provider's finance department and third party billing companies. The patient responsibility calculator 155 stores the outstanding balances determined in step 210. In another embodiment, the point of service device 110 stores any outstanding balances determined.

The insurance data processing system 160 then determines if the patient 120 has insurance that may pay for or contribute to payment for the services to be rendered during the patient's visit. In step 220, the system determines if the patient has insurance, if the insurance policy is valid and what payments a patient must make in order to cover copayments, deductibles, coinsurance or uninsured procedures. To determine if a patient has insurance and if the policy is valid, the insurance data processing system 160 contacts the insurance company databases 140 electronically via the communications system 170. As described above, in another embodiment, the insurance data processing system 160 contacts a clearinghouse that stores insurance provider information. If the patient has insurance and the policy is valid, the patient is deemed “eligible”. If the patient is deemed eligible, information regarding the patient's insurance plan is passed to the insurance data processing system 160. In one embodiment, the information is passed to the insurance data processing system 160 from the insurance company database 140 using a 271 transaction response, which is well known in the art.

As the insurance data processing system 160 has previously learned to interpret the data sent by the insurance company, the insurance data processing system 160 returns the most likely value for the patient's responsibility under the insurance plan. For example, in one embodiment, the insurance data processing system 160 determines the most likely value for the patient's copayments for various services. In yet another embodiment, the insurance data processing system 160 utilizes information from the provider's office in combination with information from the insurance company databases 140 (or clearinghouse) to determine the patient's responsibility to the provider. For example, if the provider is a specialist such as an OB/GNY, the insurance data processing system 160 will take into account that the patient is visiting a specialist. In still another embodiment, the insurance data processing system 160 determines the amount that the patient was charged for services during previous visits and uses this information to determine the patient's responsibility to the provider for the service(s) yet to be rendered. In another embodiment, the insurance data processing system 160 determines whether the provider has set an amount to charge the patient. If the provider has a set amount, the insurance data processing system 160 uses the provider-set amount as the patient's responsibility for that visit.

Next, in step 230, the system consults the medical provider's price list. The system uses the information provided by the patient regarding the purpose for the patient's visit and the expected services to be rendered, compares this patient-provided information against the price list, and determines what to charge the patient for the current visit.

The system uses the information collected in steps 210, 220 and 230 to determine the patient's overall current responsibility to the provider in step 240. Next, in step 250, the point of service device 110 outputs the amount owed the provider to the patient 120 and prompts the patient for payment. In one embodiment, the point of service device 110 is able to accept credit card and/or debit card payments. In one such embodiment, the point of service device 110 collects the patient's credit/debit card information and processes payment via the payment processor 150. The status of the payment made (copayment, outstanding balance, etc.) is stored as an additional data point for future interactions with the patient and as feedback for the insurance data processing system 160.

The system 100 determines the patient's 120 overall responsibility to the provider substantially in real-time (at the time the patient checks in at the provider's office). In certain embodiments, the system 100 is capable of making the calculation without any interaction with staff at the provider's office or at the insurance company. In other embodiments, the system 100 may determine the patient's 120 overall responsibility and collect payment from the patient 120 prior to the patient receiving the medical service. In this embodiment, the system 100 differs from traditional patient billing procedures that calculate the patient's responsibility following the patient's visit.

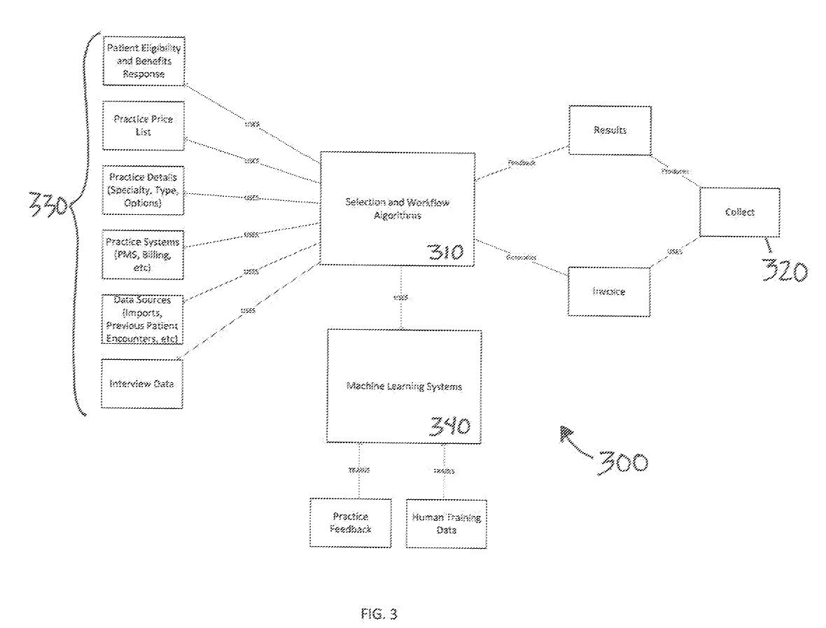

FIG. 3 block diagram of another embodiment of a system 300 for determining a patient's responsibility to a provider and illustrates the work flow of the system 300. The system 300 includes a patient responsibility calculator 310, a collection device 320 for collecting information from the patient, several data sources 330 and a machine learning system 340. The device 320 is used to collect information from the patient upon check in. The device 320 may be the point of service device 110 described above or any other type of device that a patient may use to check-in at a provider. Upon patient check in, the device 320 contacts the patient responsibility calculator 310 to determine the amount owed by the patient. The patient responsibility calculator 310 utilizes information from the data sources 330 to determine the amount due from the patient. The data sources include information from insurance companies regarding patient eligibility and benefits, the provider's practice price list, details about the provider's practice (specialty, type, options), the provider's practice systems (PMS, billing, etc.), patient interview data, and other data sources that have information that may be relevant to determining the amount owed by the patient (imported data from other providers, previous patient encounters, etc.).

In one embodiment, the patient responsibility calculator 310 utilizes the machine learning systems 340 to help interpret the information received from the databases 330, particularly from the insurance company databases. The machine learning systems 340 use human training data and practice feedback to interpret data from the databases 330. The importance of and process used by the machine learning systems 340 was described above in the discussion of FIG. 1 of how the insurance data processing system 160 is trained. The machine learning systems 340 enable the patient responsibility calculator 310 to interpret the information received from the databases 330. In one embodiment, the machine learning systems 340 are part of the patient responsibility calculator 310.

Once the patient responsibility calculator 310 determines an amount owed by the patient, it transmits an invoice to the collection device 320, which may then prompt the patient for payment. The collection device 320 then transmits the results of the patient being prompted for payment. The results may include the amount paid by the patient, the method of payment, etc. This information will be utilized by the patient responsibility calculator 310 to determine the amount owed by the patient at the patient's next visit to the provider. The information may also be utilized by the provider's practice systems. For example, the provider's practice billing system may use the payment information to generate an invoice if needed.

As described above in the discussion of FIG. 1, in other embodiments, the patient responsibility calculator 310 may be part of the collection device 320. The overall operation of the system 300 remains the same.

The techniques described above can be implemented in digital electronic circuitry, or in computer hardware, firmware, software executing on a computer, or in combinations of them. The techniques can be implemented as a computer program product, i.e., a computer program tangibly embodied in tangible, machine-readable storage medium, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps of the techniques described herein can be performed by one or more programmable processors executing a computer program to perform functions described herein by operating on input data and generating output. Method steps can also be performed by, and apparatus of the invention can be implemented as, special purpose logic circuitry, e.g., an FPGA (field programmable gate array) or an ASIC (application-specific integrated circuit). Applications can refer to portions of the computer program and/or the processor/special circuitry that implements that functionality.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Storage media suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

A computing system implementing the invention can include clients and servers. A client and server are generally remote from each other and typically interact over a communication network. The relationship of client and server arises by virtue of computer programs running on the respective computers and having a client-server relationship to each other.

Having described various embodiments of the invention, it will now become apparent to one of skill in the art that other embodiments incorporating the concepts may be used. It is felt, therefore, that these embodiments should not be limited to the disclosed embodiments, but rather should be limited only by the spirit and scope of the following claims.

What is claimed is:

1. A system for determining a patient's responsibility to a provider comprising:
a point of service device for receiving information from a patient and for processing a payment transaction; and
a patient responsibility calculator in communication with the point of service device, the patient responsibility calculator determining substantially in real-time an amount owed by the patient for a service to be rendered prior to the patient receiving the service.

2. The system of claim 1 wherein the point of service device receives the information from the patient upon the patient checking in at a provider's location.

3. The system of claim 1 further comprising a payment processor in communication with the patient responsibility calculator, the payment processor processing payment for the amount owed by the patient.

4. The system of claim 3 wherein the payment processor processes payment prior to the patient receiving the service.

5. The system of claim 3, wherein the point of service device is capable of collecting payment from the patient.

6. The system of claim 1 wherein the patient responsibility calculator further comprises an insurance data processing system receiving information relating to a patient's insurance plan from an insurance provider, wherein the patient responsibility calculator utilizes the information from the insurance data processing system to determine the amount owed by the patient.

7. The system of claim 6 wherein the insurance data processing system determines if the patient has insurance, whether the patient's insurance is valid and coverage provided by the patient's insurance.

8. The system of claim 6 wherein the insurance data processing system receives information relating to a patient's insurance plan from a clearinghouse that stores information for a plurality of insurance companies.

9. The system of claim 6 wherein the insurance data processing system is capable of interpreting data from a plurality of insurance companies.

10. The system of claim 9 wherein the insurance data processing system must exceed a predetermined certainty threshold in order to provide insurance coverage information to the patient responsibility calculator.

11. The system of claim 1 further comprising a payment database in communication with the patient responsibility calculator, wherein the payment database stores an amount previously charged to a patient, and wherein the patient responsibility calculator uses the amount previously charged to the patient to determine the amount owed by the patient for the service.

12. The system of claim 1 wherein the patient responsibility calculator utilizes a predetermined provider price list to determine the amount owed by the patient.

13. The system of claim 1 wherein the patient responsibility calculator utilizes a predetermined amount to be charged to a patient for a service to determine the amount owed by the patient.

14. The system of claim 1 wherein the patient responsibility calculator utilizes an outstanding patient balance to determine the amount owed by the patient.

15. The system of claim 1 wherein the patient responsibility calculator receives data from a plurality of provider databases.

16. The system of claim 15, wherein the patient responsibility calculator receives data from the group consisting of a practice management system, a practice finance department and a third party billing company.

17. A method for determining a patient's responsibility to a provider, comprising:
receiving patient information at a point of service device from a patient;
receiving insurance information relating to a patient's insurance plan from an insurance provider at an insurance data processing system; and
determining, by a patient responsibility calculator, substantially in real-time an amount owed by the patient for a service using the patient information and the insurance information prior to the patient receiving the service.

18. The method of claim 17 further comprising the point of service device performing the steps of:
prompting the patient to pay for the amount owed; and
receiving payment for the amount.

19. The method of claim 17 further comprising the insurance data processing system performing the steps of:
determining if the patient has insurance;
determining whether the patient's insurance is valid when the patient has insurance; and
determining coverage provided by the patient's insurance when the patient's insurance is valid.

20. The method of claim 17 wherein the insurance data processing system receives information relating to a patient's insurance plan from a clearinghouse that stores information for a plurality of insurance companies.

21. The method of claim 17 wherein the insurance data processing system is capable of interpreting data from a plurality of insurance companies.

22. The method of claim 21 further comprising the insurance data processing system performing the steps of;
calculating a certainty value of the interpreted data relating to the coverage of the patient's insurance plan;
determining if the calculated certainty value exceeds a predetermined certainty threshold; and
providing the insurance coverage information to the patient responsibility calculator when the calculated certainty value exceeds the predetermined certainty threshold.

23. The method of claim 17 wherein the step of determining substantially in real-time the amount owed by the patient for a service further comprises using an amount previously charged to the patient for the service.

24. The method of claim 17 wherein the step of determining substantially in real-time the amount owed by the patient for the service further comprises utilizing a predetermined provider price list.

25. The method of claim 17 wherein the step of determining substantially in real-time the amount owed by the patient for the service further comprises utilizing a predetermined provider-set amount to be charged to a patient.

26. The method of claim 17 wherein the step of determining substantially in real-time the amount owed by the patient for the service further comprises utilizing any outstanding patient balance.

27. The method of claim 18 further comprising the step of:
storing, by the patient responsibility calculator, a status of payment made for use in future calculations.

28. A system for determining a patient's responsibility to a provider comprising:
a point of service device for receiving information from a patient and for processing a payment transaction; and
an insurance data processing system in communication with the point of service device, the insurance data processing system receiving information regarding a patient's insurance plan from an insurance provider, and prior to the patient receiving services, determining substantially in real-time an amount owed by the patient for the services.
